(19) United States
(12) Patent Application Publication
(10) Pub. No.: US 2015/0242736 A1
(43) Pub. Date: Aug. 27, 2015

(54) SYSTEM AND METHOD FOR MARKING PRODUCTS

(71) Applicant: Yariv Glazer, Ann Arbor, MI (US)

(72) Inventor: Yariv Glazer, Ann Arbor, MI (US)

(21) Appl. No.: 14/561,187

(22) Filed: Dec. 4, 2014

Related U.S. Application Data
(63) Continuation-in-part of application No. 13/501,323, filed on Apr. 11, 2012.
(60) Provisional application No. 61/358,051, filed on Jun. 24, 2010.

(51) Int. Cl. G06K 19/06; G06Q 10/08

(52) U.S. Cl. CPC G06K 19/06; G06Q 10/087

(57) ABSTRACT

A system and method of marking a product, by creating unique taggants at a plurality of steps during the manufacturing or distribution process and applying said unique taggants on the product at the plurality of said steps. The taggants are durable and persistent, surviving, intact, processing and production steps that transforms the product. The unique taggants use unique monomers sequences, that can be associated with process steps. The resulting plurality of taggants persisting on the product hold the products life cycle history data.

### CROSS REFERENCE TO RELATED APPLICATIONS

This is a Continuation-in-Part of U.S. Utility patent application Ser. No. 13/501,323, filed Apr. 11, 2012. Application Ser. No. 13/501,313 claims priority to Patent Co-operation Treaty application number PCT/US2011/041341, filed Jun. 22, 2011. PCT/US2011/041341 claims priority to provisional U.S. Utility patent application Ser. No. 61/358,051 filed Jun. 24, 2010.

### FIELD OF INVENTION

This invention relates to the class of Combinatorial, chemistry technology: method, library, apparatus. This invention relates to the sub-class of Method specifically adapted for identifying a library member. Specifically, this invention teaches a method and system for installing a historical record on a product at various stages of manufacturing and distribution by using micro-taggants.

### BACKGROUND OF INVENTION

The economy has changed, and with it, new challenges have arisen. One of those challenges concerns the source and legitimacy of products. With an increasingly globalized economy the source of products, such as food stuffs, electronics, and automobiles, is increasingly murky. Counterfeit goods markets exist for pirated luxury goods and DVDs, amongst other goods. Illegal goods markets, mostly for illicit drugs and ivory, thrive.

Food and manufactured goods share a common problem in times of crisis or recall: the inability to quickly identify the sources of goods. Often, the product has been touched by so many sub-suppliers, spread out over such a large geographic area, that traceability is time-consuming and cumbersome. This inability carries high economic and social costs. For example, The United States Center for Disease Control (“CDC”) estimates that each year roughly 1 in 6 Americans (or 48 million people) get sick, 128,000 are hospitalized, and 3,000 die of foodborne diseases. The scope of this problem is exacerbated by the relatively antiquated and slow methods used by the CDC and the agricultural, restaurant, and grocery industries to track and dispose of tainted goods. Unknowingly, most Americans will eat tainted foods twice every decade.

Slow and antiquated tracking methods are also used to identify the source and origin of recalled automotive components. In 2014, General Motors, alone, recalled over 28 million cars, worldwide. Other automakers experience similar recall issues. Honda and other automakers have been forced to recall almost 8 million vehicles for faulty airbags, alone. Toyota experienced a sudden acceleration problem, affecting approximately 8 million vehicles, that took it years to identify, and years to work through the backlog of recalled vehicles.

Luxury goods and bootlegged intellectual property share a related problem: they are subjected to competition with counterfeit products. According to a report from the Organization on Economic Co-operation and Development (“OECD”), counterfeit trade accounts for 5-7% of the global economy. That means that counterfeit trade is a problem measured in trillions of USD, not billions of USD.

The illegal goods trade shares a third, related, problem: the goods are highly fungible, making tracking of the product almost impossible. This leads to at least three problems with high social cost. First, it is very difficult to apprehend members of the distribution network without testimony from other members of the distribution network. This has caused drug gangs to get ever more violent, to intimidate any potential witnesses into silence. Second, it also means that the large amount of drugs held in evidence rooms in different jurisdictions have a strong allure to bad actors. Stories are rampant about police evidence rooms being compromised and kilos of cocaine, marijuana, and other drugs, being stolen. Third, as marijuana becomes legal in certain jurisdictions, while remaining illegal in others, the source of marijuana is often the subject of contention at trial.

The above, seemingly unrelated, problems share a common need: a system or method that could store the history of the product on the product, itself. For example, consider a simplified recipe for bread that may contain wheat flour, sugar, corn syrup, salt, and yeast. At some point in the life cycle of the bread, a railcar of wheat is delivered to an industrial flour mill. The mill grinds the flour, potentially using more than one kind of wheat, from more than one railcar. The flour is often bleached. Then the flour is packed into 50 pound bags used by commercial bakeries. At the commercial bakery, the 50 pound bag is combined with the correct proportion of other ingredients, all arriving in equally large packaging. The output is a loaf of bread. In order to most easily trace the origins of the loaf of bread, it would be easiest if a persistent taggant were added at each step of production and distribution, that was inert. By sampling the bread, one could ascertain the source of the railcar(s) of wheat, the flour mill, the packaging and machinery used to bag the flour, and similar information for the other ingredients. A system like this could just as easily be used with an automobile, quickly identifying source information for the airbag and airbag inflator, such as supplier, manufacturing plant, date of manufacture, assembly line, shift, sub-components, etc.

There is a clear and distinct market need for a method and/or system for introducing both source and history information into a product in retrievable, relatively non-destructible and inert manner. Such a marking method or system will enable investigators to determine the source and history of a product even after it has been converted to another form, through part of a manufacturing process. It would also allow source determination when all product packaging has been disposed of and destroyed. The method or system needs to be able to track such products in order to detect patterns of use and distribution. It would help if such a system worked even when parts or ingredients were added to a product, and then were subsequently transformed through mixing, baking, heating, stamping, welding, and other similar agricultural, industrial, or commercial means.

### REVIEW OF PRIOR ART

Various techniques have been used for marking or tagging products in order to enable tracking a product or determining the source of a product under examination, and its constituents. These techniques are far from perfect, and certainly do not meet the market need. For example, tagging ingredients have been added to chemical compositions, and radio-frequency identifications (RFID) labels have been applied to product containers and clothing. However, in the known techniques, the tag is usually destroyed or removed upon the transformation or conversion of the product into another form, thereby precluding the identification of the source of the product. Moreover, only a single tagging is used on each product, limiting its usefulness in determining the products life cycle history.

A survey of the current prior art shows several attempts to address the problem, all without success. For example, U.S. Pat. No. 5,139,812 by named inventor Lebacq, granted in 1992, is entitled, “Method and apparatus for high security crypto-marking for protecting valuable objects” (“Lebacq '812”). Lebacq '812 discloses a marking method and apparatus for use with unique, high value objects, such as original artwork. Lebacq '812 teaches method of applying a single taggant of nucleic acid onto an object. If the need arises, the user can identify or authenticate, “the object by bringing a probe means including a chemical agent reactive with said target nucleic acid into contact with said target nucleic acid, and detecting a reaction between said agent and said target nucleic acid . . . ” Lebacq '812, claim 1. Lebacq '812 does not disclose encoding any information into the nucleic acid. Lebacq '812 does not disclose applying multiple, unique nucleic acids to a single object to provide a history of the object's product life cycle. Lebacq '812 does not teach storing the product history data on or in the product, itself.

U.S. Pat. No. 6,705,516 by named inventor Kubota, issued in 2004, is entitled, “Product management apparatus and product with historical information recording device” (“Kubota '516”). Kubota '516 teaches a product management apparatus/system, for tracking the history of a product, in which a main unit, capable of transmitting and receiving a signal, is attached to the product. Clearly, this would require electronics to be attached to the product, in the body of the main unit, meaning that this system would not work for anything that went through any type of transformation such as pressing, mixing, heating, molding, welding, or other similar industrial processes. Kubota '516 teaches that the product history would be remotely stored on a memory device. Kubota '516 does not teach about taggants, whatsoever. Kubota '516 does not teach about applying multiple, unique taggants to a product. Kubota '516 does not teach storing the product history data on or in the product, itself. Kubota '516 is classified, by the United States Patent and Trademark Office (“USPTO”) in the USPC class for Registers and the sub-class for Systems Controlled by Data Bearing Records.

U.S. Patent Application 20100099080, by named inventors Church, et. al., entitled, “Nucleic acid memory device,” was filed Jun. 21, 2007, published Apr. 22, 2010, and abandoned Apr. 6, 2012 (“Church '080”). Church '080 was abandoned pursuant to a non-responsive amendment subsequent to a species election. Church '080 is filed by the USPTO in the USPC class for Chemistry: Molecular Biology and Microbiology, and the primary sub-class for Drug or compound screening involving gene expression (USPC 435/6.13). Dr. Church runs a molecular biology lab, bearing his name, at Harvard University. Church '080 teaches a method for encoding information into nucleic acid, in order to make memory devices for bio-computation. Church '080 states, “Bio-computation is aimed at exploring and developing computational methods and models at the bio-molecular and cellular levels. However, this field has focused on computational algorithms rather than Input/Output (I/O) and memory. For example, present DNA-enzyme clock rates are typically six logs slower that the GHz expected of electronic-optical (EO) computing. Accordingly, input, output and memory options are needed.” Church '080 at 0003. Church '080 does not teach using nucleic acids for taggants. Church '080 does not teach using multiple unique nucleic acids to repeatedly mark a product during the product's life cycle. Church '080 does not teach, disclose, or anticipate that nucleic acids would resist decomposition or de-polymerization in a wide variety of industrial processes used to transform matter and products. Church '080 does not teach storing the product history data on or in the product, itself.

U.S. Pat. No. 8,866,108, by named inventor Direny, issued in 2014, is entitled, “Microtagging motor vehicles for identification from a paint sample discovered during a criminal investigation” (“Direny '108”). Direny '108 teaches a system and method in which unique micro-taggants are added to the paint of an automobile, prior to spray application. The micro-taggants would identify the particular vehicle's paint, making it possible to pre-suppose that such paint came off of said vehicle during a criminal investigation. Direny '108 discloses that the micro-taggant would be microscopic, and it would be readable using an ultraviolet light and microscopic magnification. Direny '108 teaches that the micro-taggants would be an encrypted, unique identifier. Direny '108 does not teach applying multiple, unique taggants to a single product, during the product's life cycle. Direny '108 does not teach using nucleic acid, polysaccharides, or other monomers as taggants. Direny '108 does not teach storing the product history data on or in the product, itself.

U.S. Pat. No. 8,735,327, by named inventor Macula, issued in 2014, is entitled, “Combinatorial DNA taggants and methods of preparation and use thereof” (“Macula '327”). Macula '327 discloses creating a table of table-mers, each entry with a unique nucleotide sequence. Macula '327 discloses combining the various combinations of nucleotides in the table to make Combinatorial DNA. The Combinatorial DNA would then be used as a taggant. Macula '327 further discloses associating an alphanumeric sequence with the Combinatorial DNA. Macula '327 does not disclose encoding alphanumeric information into the Combinatorial DNA, only one-to- one mapping of alphanumeric sequences with unique Combinatorial DNA. Macula '327 does not teach repeatedly applying unique taggants to record the history of a product, on the product, during the product's life cycle. Macula '327 does not teach using polysaccharides, inorganic monomers, or amino acids to encode information. Macula '327 does not teach using yeast, bacterium, or nano-particles as taggants, carrying the monomers with the encoded information.

The various techniques of marking or tagging products, as disclosed by the prior art, have failed to meet the market need. None of the methods listed above, nor any method available on the market, solve the problems discussed: how to mark a product, as it goes through serial transformations, so that the products life cycle history is conveniently and accurately stored on the product, itself.

### SUMMARY OF THE INVENTION

The present invention improves and expands upon the current prior art by teaching a marking method and system that uniquely marks the constituents, either bulk or discrete, that become a product, through the life cycle of the constituents and product, including all transforming or partitioning processes. Further the present invention teaches a marking method and system, wherein the product, itself, can be uniquely marked at each stage, step, or transformation in the manufacturing or distribution process. In one embodiment, the information encoded into each unique tag can be in the form of pre-defined text fields. In this embodiment, the history will be easily readable with any appropriately programmed and capable reader. This differs from current methods, substantially, because the data will be stored on the product, as part of the tag. The algorithm for deciphering the product history can be added to any electronic device. Current methods store the product history on a fixed database, separate from the product, and associate the history to the product by the tag attached to the product. This risks the destruction of the product history, either accidentally or intentionally.

The present invention, in all embodiments, provides a method and system for introducing both source and history information into a product in a coded, retrievable and relatively non-destructible manner, to enable determining the source and history of a product even after it has been converted to another form. The invention provides a method of tracking such products in order to detect patterns in the use of such products. Products would have the taggant added to the product at various steps in the manufacturing or distribution processes.

The basic system of the invention comprises using a processor for producing encoded information concerning a specific point in the product's life-cycle (e.g., location, source, process, time of day, day of week); converting or associating the encoded information into a unique monomers sequence, which is relatively durable and non-destructible; using the unique monomers sequence as a taggant, and applying the taggant to the product at said specific point in the product's life cycle; repeating the tagging process at additional specific points in the product's life cycle, said repetitive tagging not over-writing or destroying any prior tags; and an analysis means which can identify the plurality of taggants present on a product at a particular point in its product life cycle and decode all of the taggants, revealing the product's life cycle history, to date. The unique monomers sequences would withstand common and multiple manufacturing and processing steps, including, but not limited to heating, baking, mixing, cutting, pressing, welding, and stamping. At any point in time, the history of the product would reside, encoded, on the product, itself. The taggant is initially suspended in a fluid of proper viscosity. The suspension is designed to evaporate or de-compose, leaving only the taggant and inconsequential residue. The taggant may be added to the bulk of a material, applied as a surface coating, or impregnated into permeable materials. During the life cycle of a single product, unique taggants may be added to the bulk, as surface coatings, and impregnated into the wrapping, surface, or bulk of the product, itself.

The basic method of the invention comprises encoding information concerning a specific point in the product's life-cycle (e.g., location, source, process, time of day, day of week); converting or associating the encoded information into a unique monomers sequence, which is relatively durable and non-destructible; using the unique monomers sequence as a taggant, and applying the taggant to the product at said specific point in the product's life cycle; repeating the tagging process at additional specific points in the product's life cycle, said repetitive tagging not over-writing or destroying any prior tags; and an analysis means which can identify the plurality of taggants present on a product at a particular point in its product life cycle and decode all of the taggants, revealing the product's life cycle history, to date.

The invention, thus, broadly involves the concept of encoding products with source and history information and using the product as an information storage device in a manner enabling such information to be retrieved at a later time by others even after the product receiving the information has been transformed into another form. In one embodiment, the information stored on the monomers sequence can be encoded text with pre-defined field lengths. In this embodiment, a simple algorithmic decoding would reveal the product history in appropriately formatted text fields.

Current prior art discloses systems and methods that introduce identification information in a coded form into a new cell structure for purposes of identifying the new cell structure, in order to detect unauthorized copying. The present invention is distinguishable from the prior art because the information introduced by the code includes both source and history information, to thereby identify not only the source but also the history of an examined product despite transformations which may have occurred in the product.

The unique monomers sequence can be in many forms, such as in the form of a unique nucleic acid sequence (NAS), a unique amino acid sequence (AAS), a unique polysaccharides sequence (PS), a unique inorganic monomer sequence (IMS), etc., embedded in or added to the product. The unique inorganic monomers sequence can be common inorganic materials such as silicon, germanes, and stannanes. These inorganic monomers serve as the backbone for the polymers polysilicon, polygermanes, and polystannanes, respectively.

The code, as stored in the polymer made from the monomers, can be encapsulated in a yeast, a plant, or bacteria. It can also be encapsulated inside a capsule or nanoparticles. So, a unique monomers sequence can either be represented using nanoparticles, or can be encapsulated inside nanoparticles. Encapsulating techniques, include, but are not limited to, nano-caging, wherein natural or synthetic monomers create hydrogel nanoparticles, silica nanoparticles, and polymerized micelles. The source and history information could be: (a) incorporated into the product itself, (b) added directly to the product or (c) encapsulated in a capsule added to the product.

The information can be encoded into the unique taggant using any available and capable encoding technology. For example, a number is assigned to each element of the code, and the numbers are converted into the code introduced into the product by arranging the numbers into a numerical sequence; converting the numerical sequence into a hexadecimal sequence; and converting the hexadecimal sequence into the code.

### BRIEF DESCRIPTION OF THE DRAWINGS

The invention is illustrated by FIG. 1-FIG. 8.

FIG. 1 is a block diagram of the tagging method.

FIG. 2 is a flowchart of the process.

FIG. 3 is a block diagram of a field definition and encoding.

FIG. 4 is a flowchart of an example application.

FIG. 5 is a flowchart of the invention, showing its application in an agricultural setting.

FIG. 6 is a flowchart illustrating the inventions application in an industrial setting.

FIG. 7 is a flow diagram illustrating the conversion of code into a unique monomers sequence.

FIG. 8 is a table illustrating an example of converting the code into a unique monomers sequence.

### DETAILED DESCRIPTION

FIG. 1 is an overall flow chart illustrating the method of the present invention for introducing source information into a product in a coded, retrievable, and relatively non-destructible manner. In the preferred embodiments of the invention described below, the source information is introduced into the products such that the source of each product, even after the products has undergone transformation, can be later identified, and also such that subsequent operations performed on the product can be tracked to prepare a history profile of the product, to thereby enable detection of patterns or coincidences that may require action.

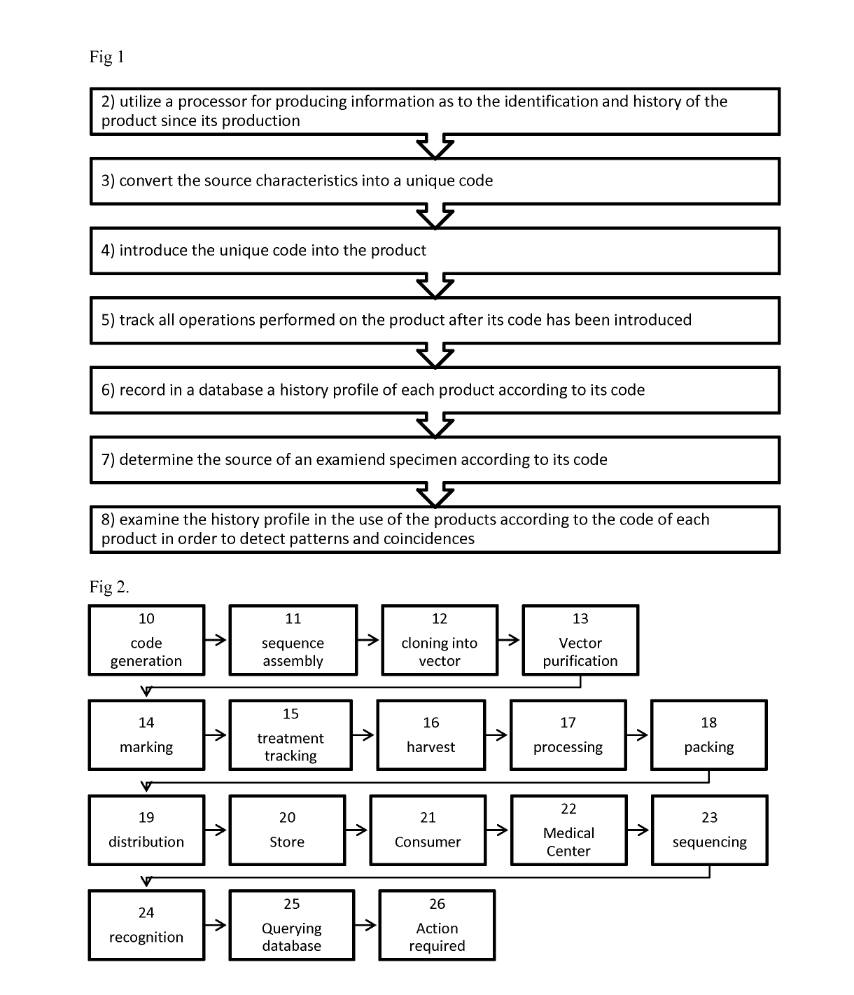

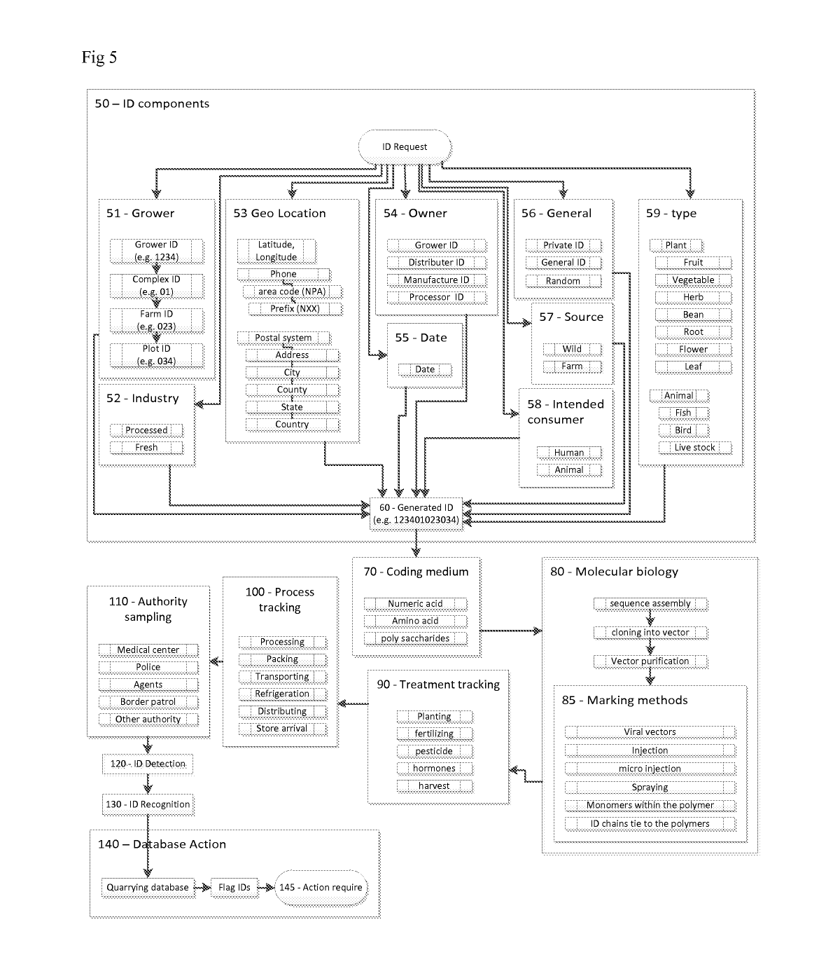

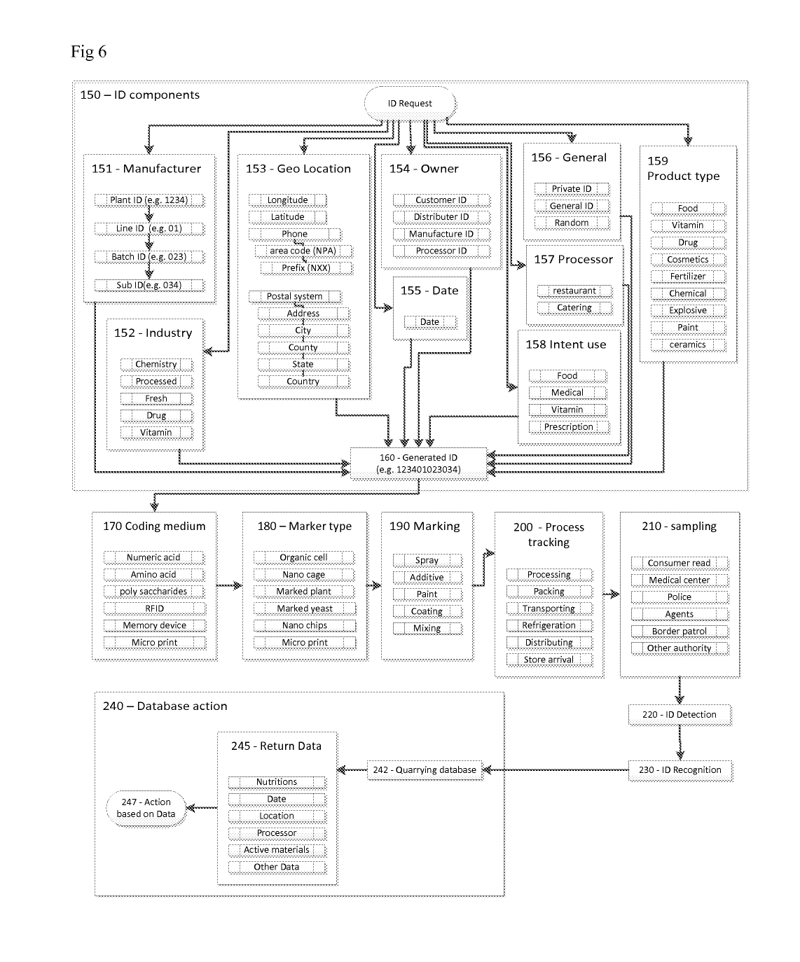

Thus, as shown by FIG. 1, the first operation is to prepare a profile of source characteristics identifying the source and history of the respective product (block 2); convert the source characteristics into a unique code (block 3); and introduce it into the product (block 4). FIG. 2 block 10, FIG. 5 block 50, and FIG. 6 block 150 described below illustrate examples of performing the operations of block 2 of FIG. 1; FIG. 2 blocks 11-13 and FIG. 5 blocks 70-80 illustrate examples of performing the operations of block 3 of FIG. 1; FIG. 2 blocks 14 and FIG. 5 block 85 illustrate examples of performing the operations of block 4 of FIG. 1; FIG. 2 blocks 15-21 and FIG. 5 blocks 90-100 illustrate examples of performing the operations of blocks 5 and 6 of FIG. 1; FIG. 2 blocks 22-25 and FIG. 5 blocks 110-140 illustrate examples of performing the operations of block 7 of FIG. 1; and FIG. 2 block 26 and FIG. 5 block 145 illustrate examples of performing the operations of block 8 of FIG. 1.

As shown by blocks 5 and 6 of FIG. 1, all operations performed on the product, after its unique code has been introduced into it, are tracked and recorded in a database, thereby providing a history profile of each product according to its code. As indicated by blocks 7 and 8, the forgoing operation permit the source and history information of the product to be later identified, even though the product has undergone substantial transformations, and also permit patterns to be detected resulting from the use of the product according to the code of the product.

With reference to the block diagram illustrated in FIG. 2, the first step 10 is the code generation in which; a numerical code is mathematically generated from the source and the history path of the product (FIG. 5, block 50); the code is translated into, e.g. a nucleic acid sequence, and a database record is created for that code.

Block 11, 12 and 13 represent the lab work of creating the unique nucleic acid sequence. This starts with the assembly of the sequence (11) where the nucleic acid monomers are joined together in a specific order to form a polymer representing the code. The next step (12) is to replicate the code a multiple of times (e.g., cloning into vector) to create a mass that can mark the plant (block 14). Before the marking process 14, the replicated vectors undergo a purification process (13) to ensure the correct chain for the marking.

Marking the plants (block 14) can be done by a known process, such as DNA bombardment, agrobacterium infiltration, viral vectors, etc.

The so marked plant is sent to the field for replanting, growing, and harvesting. Each of the steps along the plant's life is recorded in the database (block 15) from the replantation and up to the harvest (block 16) when the harvested product leaves the farm.

Blocks 17, 18, and 19 represent the processing of the harvest into an agricultural product. This includes processing (block 17), packing (block 18), and distributing the product (block 19), to the stores (block 20). Each of the steps has checkpoints where the operator updates the database when the product is passing through the respective step.

In the event a consumer (block 21) enters a medical center (block 22) for diagnosis or treatment, the medical center samples the stomach contents and sends the sample for sequencing (block 23), where the code, e.g., nucleic acid chain, can be retrieved and the order of its various elements, e.g., monomers, can be determined (block 24). The medical center had previously entered the determined sequence into the database (block 23) with the symptoms found in the patient.

A database process checks to see if this sequence, or a checkpoint along its path, was queried from any medical center. In the event that the database process finds that such a query was indeed made, the database alerts (block 24) the authorities for further actions. Thus, the checks can identify similar patterns and there by facilitates locating the source of, e.g., a contamination, in the history of a particular food product.

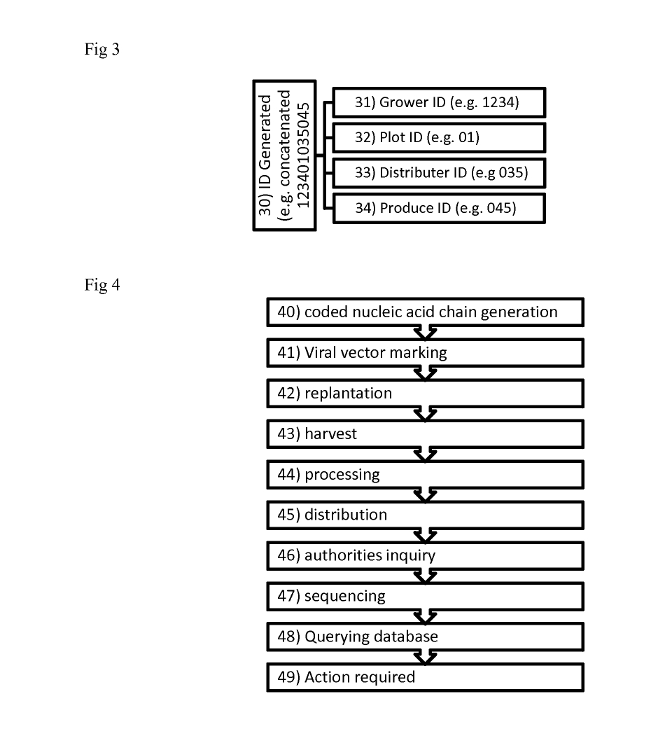

FIG. 3 illustrates one manner of converting the identification characteristics of the product into a unique code when marking of agricultural products with unique code source identifications. Thus, a number is assigned to each element of the source information to be introduced into the product to generate a source code constituted of a sequence or concatenation of numbers (block 30). In the example illustrated in FIG. 3, the generated source includes identification of the grower (31), the plot (32), the distributor (33), and the product (34) e.g., the name of the agricultural product.

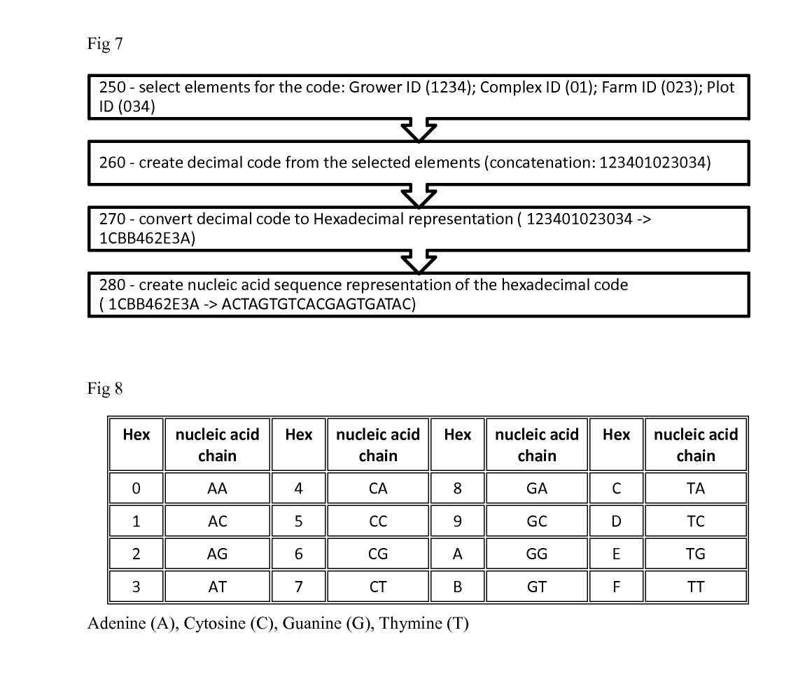

FIG. 7 illustrates the manner in which the numerical sequence illustrated in FIG. 5 is produced. Thus, the numbers assigned to the elements of the source and history information are converted into a code introduced into the product by: arranging the numbers in a numerical sequence; converting the numerical sequence into a hexadecimal sequence; and converting the hexadecimal sequence into the code. FIG. 8 is an example a conversion table for converting hexadecimal digits to nucleic acid dimers.

A particularly important application of the invention is distinguishing an illegal marijuana drug form a legal marijuana medication. Thus, one of the greatest fears of the medical marijuana industry is that their products will enter the black market. By the use of this invention to tag all legally grown marijuana, the authorities will be able to easily identify the source of any particular specimen of marijuana. This will stop the flow of marijuana from the legal market to the illegal market and can be used to identify marijuana farmers that are abusing the legal marijuana system. Marijuana farmers who grow marijuana and sell it illegally can then lose their license to grow the legal marijuana. Marijuana designated for legal use can also be checked by authorities to make sure that all medical marijuana was grown legally by farmers with licenses.

FIG. 4 is illustrates the implementation of the invention for medical marijuana control. Block 40 shows the creation of the coded nucleic acid chain generation as shown in FIG. 2, blocks 10-13. The next step shows the marking process called viral vector (block 41) where the coded nucleic acid chain enters into a viral vector and infects the marijuana plant cells. 0040 After the plant is marked, the grower receives the plants for replanting (block 42) in the respective growth environment. At harvest (block 43), the grower enters into the database a new entry for the harvested batch indicating the destination of that batch. The marijuana batch moves through processing and distribution (blocks 44 and 45) before arriving to the patient.

When an authority agent inquires (block 46) as to a particular marijuana product a sample is sent for sequencing (block 47), and the results are queried against the database (block 48). In the case of a ‘no code found’ in a patient batch, or a ‘code OK’, in a street batch, the agent will receive an ‘Action required’ alert (block 49).

FIG. 5 illustrates the main steps, and many variations thereof, with respect to marijuana or other agricultural products. Block 50 describes many designated classifications for building the code, including: grower information (block 51); the respective industry such as processed food or fresh uncut food (block 52); geographic location information (block 53) including longitude, latitude, phone area code, NXX, postal zip code, or the general form of country, state, county, city, and address codes; ownership information (block 54), of the agricultural product in the situation where the crop is grown for a specific distributer, manufacturer, processor, or growers co-op; important date information (block 55) in the life of the product, such as seeding, planting, harvesting, end of life, or even just the simple year of operation; general information regarding unique codes (block 56), representing the crop or the product, specific license code, encryption key, validation codes, etc.; growth source information (block 57) indicating if the crop came from a farm, open field, green house, wild, etc.; intended consumer (block 58), e.g. such as animal feed or human consumption and the type of plant or animal (block 59).

Block 60 of FIG. 5 illustrates one possible example of a generated code from the step of block 51, wherein the code is a concatenated number representing the grower ID (1234), the farm complex ID (01), the farm within the complex (023), and the plot within the farm (034).

FIG. 5, block 70 illustrates possible options for coding the information into a medium that can be added to organic cells such as nucleic and amino acid, or polysaccharides. Block 80 illustrates the process when using nucleic acid chain to store the code and block 85 describes some known marking methods for introducing the code into a life cell. When the code has been introduced to the life plant cell, the farmer records the steps in the course of the growth of the plant (block 90) such as: replanting, fertilizing, pesticide, hormone treatments, and harvesting to name a few. After the harvest, the processing, refrigerating, packing, and distribution processes and facilities are tracked (block 100), until the crops become agricultural products. Along this path, every time that the crop batch enters and exits a process, the operator of that process enters a record into the database creating a history path for that batch.

Block 110 of FIG. 5, titled “authority sampling”, shows possible entities that might need to retrace the product's source and history information, such as medical centers—in case of medical emergency, police, inspection agents, border patrol, and others. After an agent samples the product, ID detection (block 120) and recognition (block 130) are performed to extract and identify the coding medium using well known sequencing technologies. The sequence is entered into the database (blocks 140) to retrieve the source and history information recorded during the previous steps. In the case where the same ID was queried more than once, the database can flag and alert the agent for further action (block 145).

FIG. 6 illustrates many possible embodiments of the invention for manufacturing industrial products. Block 150 describes many classifications or ID components for building the code including: manufacturer information (block 151); industry information (block 152); geographical location information (block 153); ownership information of the product, including distributer, manufacturer, processor, or customer (block 154); important dates in the life of the product, such as manufacturing, assembly, processing, end of life, or even just the simple year of operation (block 155); unique codes (block 156) representing the product, specific license code, encryption key, validation codes, etc.; processor information (block 157) e.g. indicating restaurant, catering, pharmacy, packing facility, etc.; target market (block 158), such as food, medicine, vitamin, etc.; and product type (block 159) such as food, vitamin, drug, cosmetics, fertilizer, chemical, explosives, paint, ceramics, etc.

Block 160 of FIG. 6 illustrates one possible example of a code generated from block 151, where the code is a concatenated number representing the factory ID (1234), the line ID (01), the batch number (023), sub-ID within the batch (034), etc.

FIG. 6 block 170 illustrates possible options for coding the information into a medium that can be added to manufactured industrial products such as code utilizing nucleic acid, amino acid, polysaccharide chains, RFID device, or memory chip, etc. Block 180 illustrates the marker type, where a marked organic cell (block 14 of FIG. 2) is used to mark an industrial product, e.g., by nano-cages encapsulating the mediums (block 170), marked plants such as parsley, marked yeast, or nano memory chips (block 180). The product marking can be in many forms, such as spray, additive, paint, coating, or mixing the marker with the product (block 190). When the code has been introduced into the product, the product undergoes many further stations or steps where the processor records in the database the respective station or step, such as a processing operation, packing, transportation, refrigeration, distribution, etc., up to the store (block 200).

Block 210 of FIG. 6 illustrates possible entities that may be involved in retracing the product's source and history information, such as medical centers—in case of medical emergency, police, inspection agents, border patrol, etc. ID detection is performed of the product of interest to extract and identify the coding medium, using well known sequencing technologies (block 220). The sequence is entered into the database (blocks 230 and 240) to retrieve the source and history information recorded (block 242) during the previous steps (blocks 150 and 200). The database reads-out the source and history information associated with this ID (block 245), and in the case where the same ID was queried more than once, the database can flag and alert the agent for further action (block 247).

1. A method to repetitively mark a product over the course of its product life cycle comprising an algorithm for encoding information concerning a specific point in time in the product's life cycle such as location, source, process, day, time of day, day of week, temperature, assembly line, operation and factory;
converting or associating the encoded information into a unique monomers sequence that is relatively durable and non-destructible; using the unique monomers sequence in a taggant, and applying the taggant to the product at said specific point in the product's life cycle; repeating the tagging process at additional specific points in the product's life cycle, said repetitive tagging not over-writing or destroying any prior tags; analyzing said product, if needed, to identify the plurality of unique monomers sequences and decoding the plurality of unique monomers sequences to reveal the products life cycle history, to date.

2. The method in claim 1, in which said monomers is in the form of nucleic acids, without regard to any specific nucleic acid sequence.

3. The method in claim 1, in which said monomers is in the form of amino acids, without regard to any specific amino acid sequence.

4. The method in claim 1, in which said monomers is in the form of polysaccharides.

5. The method in claim 1, in which said monomers is in the form of a inorganic matter.

6. The method in claim 1, in which said unique monomers sequence is encapsulated in a yeast cell.

7. The method in claim 1, in which said unique monomers sequence is encapsulated in a bacteria cell.

8. The method in claim 1, in which said unique monomers sequence is encapsulated in a plant cell.

9. The method in claim 1, in which said unique monomers sequence is encapsulated in a nanoparticle.

10. The method in claim 1, in which the algorithm defines text fields for location, source, process, day, time of day, day of week, temperature, assembly line, or factory, and encodes the information by converting said text in said text fields into binary.

11. The method in claim 1, in which the algorithm defines text fields for location, source, process, day, time of day, day of week, temperature, assembly line, or factory, and encodes the information by converting said text in said text fields to hexadecimal.

12. A system to repetitively mark a product over the course of its product life cycle comprising an algorithm for encoding information concerning a specific point in time in the product's life cycle such as location, source, process, day, time of day, day of week, temperature, assembly line, operation, and factory; one or more processors using said algorithm to encode life cycle information;
converting or associating the encoded information into a unique monomers sequence that is relatively durable and non-destructible; using the unique monomers sequence as a taggant, and applying the taggant to the product at said specific point in the product's life cycle; repeating the tagging process at additional specific points in the product's life cycle, said repetitive tagging not over-writing or destroying any prior tags; and an analysis means which can identify the plurality of taggants present on a product at a particular point in its product life cycle and decode all of the taggants, revealing the product's life cycle history, to date.

13. The system in claim 12, in which said monomers is in the form of nucleic acids, without regard to any specific nucleic acid sequence.

14. The system in claim 12, in which said monomers is in the form of amino acids, without regard to any specific amino acid sequence.

15. The system in claim 12, in which said monomers is in the form of polysaccharides.

16. The system in claim 12, in which said monomers is in the form of a inorganic matter.

17. The system in claim 12, in which said unique monomers sequence is (Original) encapsulated in a yeast cell.

18. The system in claim 12, in which said unique monomers sequence is (Original) encapsulated in a bacteria cell.

19. The system in claim 12, in which said unique monomers sequence is encapsulated in a plant cell.

20. The system in claim 12, in which said unique monomers sequence is encapsulated in a nanoparticle.

21. The system in claim 12, in which the algorithm defines text fields for location, source, process, day, time of day, day of week, temperature, assembly line, or factory, and encodes the information by converting said text in said text fields into binary.

22. The system in claim 12, in which the algorithm defines text fields for location, source, process, day, time of day, day of week, temperature, assembly line, or factory, and encodes the information by converting said text in said text fields to hexadecimal.
